(19) United States
(12) Patent Application Publication
(10) Pub. No.: US 2024/0392537 A1
(43) Pub. Date: Nov. 28, 2024

(54) SYSTEM FOR CONTROLLING MANIPULATION REACTION FORCE AND METHOD FOR CONTROLLING MANIPULATION REACTION FORCE

(71) Applicants: KOBELCO CONSTRUCTION MACHINERY CO., LTD., HIROSHIMA-SHI, HIROSHIMA (JP); HIROSHIMA UNIVERSITY, a university of Japan, Higashihiroshima-shi, Hiroshima (JP)

(72) Inventors: Ryota SEKIZUKA, HIGASHIHIROSHIMA-SHI, HIROSHIMA (JP); Masaru ITO, HIGASHIHIROSHIMA-SHI, HIROSHIMA (JP); Yuichi KURITA, HIGASHIHIROSHIMA-SHI, HIROSHIMA (JP)

(21) Appl. No.: 18/694,019

(22) PCT Filed: Mar. 31, 2022
(86) PCT No.: PCT/JP2022/016663

§ 371 Date: Mar. 21, 2024

(30) Foreign Application Priority Data
Sep. 29, 2021 (JP) 2021-159281

(51) Int. Cl. E02F 9/22; E02F 9/20; G05G 9/047

(52) U.S. Cl. CPC E02F 9/2203; E02F 9/205; G05G 9/047; G05G 2009/04766

(57) ABSTRACT

Provided is a system and the like that can improve operability of a manipulation mechanism for an operator. Manipulation reaction forces f₁(θ) and f₂(φ) acting on manipulation levers 2111 and 2112 are controlled by controlling operation of actuators 214. At this time, the manipulation reaction forces f₁(θ) and f₂(φ) are controlled to cause reaction forces F₁(θ) and F₂(φ) in manipulation directions opposite to each other perceived by the operator through manipulation levers 2111 and 2112 (manipulation mechanism) to realize symmetry about a manipulation amount of zero, within a manipulation amount range in a positive manipulation direction and a manipulation amount range in a negative manipulation direction.

### TECHNICAL FIELD

The present invention relates to a technique for causing manipulation reaction force against manipulation force to act on a manipulation mechanism operated in positive/negative manipulation directions by an operator in order to operate a work machine or a component thereof in positive/negative operation directions.

### BACKGROUND ART

Vertical and lateral pivoting mechanisms, which each include a lever supporting member as a fulcrum and are disposed on a left side and/or a right side of an operator's seat of a construction machine, are rotated by means of levers. In this case, a manipulation lever device in which a rotation axis of each of the pivoting mechanisms is obliquely disposed so as to pass through a holding center of a lever grip held by an operator has been proposed (for example, see Patent Literature 1).

However, there is a difference in how muscles act between extending/bending action and pronating/supinating action of an elbow of the operator. Therefore, different reaction forces are perceived by the operator against manipulation in an upward direction and a downward direction. This makes it difficult for the operator to grasp the manipulation amount of the lever in each direction, and operability may be deteriorated.

A manipulation lever device in which a cross switch including front, rear, left, and right switch portions pressed and manipulated by a finger of an operator is provided on a holding portion of a manipulation lever of a construction machine has been proposed (for example, see Patent Literature 2). This makes it possible to reduce fatigue of an arm of the operator manipulating the construction machine.

### CITATION LIST

### Patent Literature

Patent Literature 1: Japanese Patent Laid-Open No. 2003-184128
Patent Literature 2: Japanese Patent Laid-Open No. 2000-204599

### SUMMARY OF INVENTION

### Technical Problem

However, pressing manipulation of the cross switch by a forger requires fine and accurate fingering. Thus, a mental load on the operator may be increased, and work efficiency by the construction machine may be deteriorated.

An object of the present invention is to provide a system and the like that can improve operability of the manipulation mechanism for the operator.

### Solution to Problem

A system for controlling manipulation reaction force according to the present invention is a system for controlling manipulation reaction force configured to control operation of an actuator to cause a manipulation reaction force to act on a manipulation mechanism in a direction corresponding to a manipulation direction detected by an operating manner detection sensor, the manipulation reaction force being of strength corresponding to a manipulation amount detected by the operating manner detection sensor of the manipulation mechanism operated by an operator in a positive manipulation direction and a negative manipulation direction, which are opposite to each other, for a purpose of operating a work machine to be controlled or a component of the work machine in a positive operation direction and a negative operation direction, which are opposite to each other. The system for controlling manipulation reaction force is configured to control the operation of the actuator to cause a manipulation reaction force corresponding to the manipulation amount of the manipulation mechanism to act on the manipulation mechanism in the positive manipulation direction and the negative manipulation direction, such that a perceived reaction force is realized in at least partially a symmetrical manner about a manipulation amount of zero of the manipulation mechanism, the perceived reaction force being a manipulation reaction force perceived by the operator through the manipulation mechanism based on the manipulation amount of the manipulation mechanism in the positive manipulation direction and the negative manipulation direction.

According to the system for controlling manipulation reaction force configured as described above, the operation of the actuator is controlled based on the manipulation amount of the manipulation mechanism in each of the positive manipulation direction and the negative manipulation direction, which are opposite to each other. As a result, the manipulation reaction force acts on the manipulation mechanism. At this time, the operation of the actuator, and furthermore, the manipulation reaction force acting on the manipulation mechanism is controlled such that the reaction force (perceived reaction force) perceived by the operator through the manipulation mechanism at least partially realizes symmetry about the manipulation amount of zero within a manipulation amount rage in the positive manipulation direction (positive definition range) and a manipulation amount range in the negative manipulation direction (negative definition range). In other words, a manipulation reaction force f(X) is controlled such that perceived reaction forces F(+X) and F(−X) respectively corresponding to a manipulation amount +X in the positive manipulation direction and a manipulation amount −X in the negative manipulation direction equal in absolute value to the manipulation amount +X are equal to each other. As a result, in each of the positive manipulation direction and the negative manipulation direction, which are opposite to each other, the manipulation amount of the manipulation mechanism and the perceived reaction force by the operator are made equal to or matched with each other, which makes it possible to improve operability of the manipulation mechanism for the operator.

### BRIEF DESCRIPTION OF DRAWINGS

FIG. 1 is an explanatory diagram relating to a configuration of a system for controlling manipulation reaction force as an embodiment of the present invention.

FIG. 2 is an explanatory diagram relating to a configuration of a remote manipulation apparatus.

FIG. 3 is an explanatory diagram relating to a configuration of a manipulation lever.

FIG. 4 is an explanatory diagram relating to a configuration of a work machine.

FIG. 5 is an explanatory diagram relating to functions of a remote manipulation system.

FIG. 6 is an explanatory diagram relating to a work environment image.

FIG. 7 is an explanatory diagram relating to one mode of a method for controlling manipulation reaction force.

### DESCRIPTION OF EMBODIMENTS

### (Configuration of Remote Manipulation System)

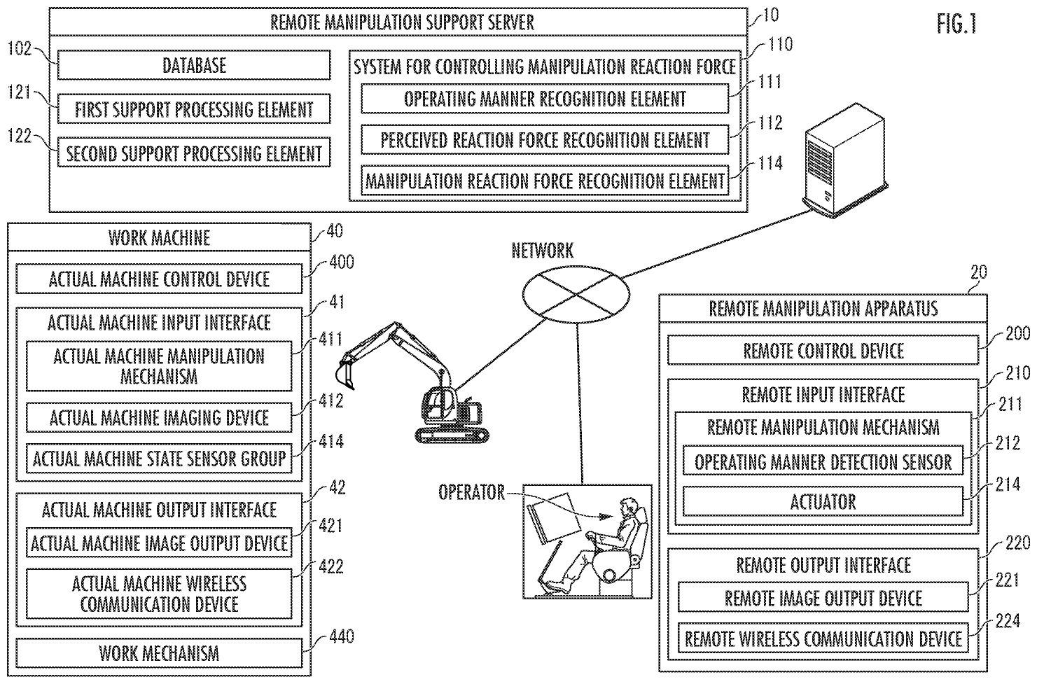

A system for controlling manipulation reaction force 110 as an embodiment of the present invention illustrated in FIG. 1 is implemented as a remote manipulation support server 10 for supporting remote manipulation of a work machine 40 by a remote manipulation apparatus 20. The remote manipulation support server 10 and the remote manipulation apparatus 20 are configured to communicate with each other through a fast network. The remote manipulation support server 10 and the work machine 40 are configured to communicate with each other through a second network. The fast network and the second network may be networks common in communication standard and the like, or may be networks different in communication standard and the like.

### (Configuration of Remote Manipulation Support Server)

The remote manipulation support server 10 comprises a database 102, the system for controlling manipulation reaction force 110, a first support processing element 121, and a second support processing element 122. The database 102 stores and holds captured image data and the like. The database 102 may be implemented as a database server different from the remote manipulation support server 10. Each of the support processing elements includes a calculation processing device (single core processor, multicore processor, or processor core constituting one of single core processor and multicore processor), reads necessary data and software from a storage device such as a memory, and performs calculation processing described below on the data based on the software.

### (Configuration of System for Controlling Manipulation Reaction Force)

The system for controlling manipulation reaction force 110 according to the embodiment of the present invention illustrated in FIG. 1 comprises an operating manner recognition element 111, a perceived reaction force recognition element 112, and a manipulation reaction force recognition element 114. Each of the elements includes a calculation processing device (single core processor, multicore processor, or processor core constituting one of single core processor and multicore processor), reads necessary data and software from a storage device such as a memory, and performs calculation processing described below on the data based on the software.

### (Configuration of Remote Manipulation Apparatus)

The remote manipulation apparatus 20 comprises a remote control device 200, a remote input interface 210, and a remote output interface 220. The remote control device 200 includes a calculation processing device (single core processor, multicore processor, or processor core constituting one of single core processor and multicore processor), reads necessary data and software from a storage device such as a memory, and performs calculation processing on the data based on the software.

The remote input interface 210 comprises a remote manipulation mechanism 211. The remote output interface 220 comprises a remote image output device 221 and a remote wireless communication device 224. The remote output interface 220 may comprise, as an information transmission unit, a sound output device in addition to the remote image output device 221.

The remote manipulation mechanism 211 includes a traveling manipulation device, a turning manipulation device, a boom manipulation device, an arm manipulation device, a bucket manipulation device, an operating manner detection sensor 212, and actuators 214. Each of the manipulation devices includes a manipulation lever receiving rotating manipulation. The manipulation lever of the traveling manipulation device (traveling lever) is manipulated to move a lower travelling body 410 of the work machine 40. The traveling lever may also serve as a traveling pedal. For example, the traveling pedal fixed to a base part or a lower end part of the traveling lever may be provided. The manipulation lever of the turning manipulation device (turning lever) is manipulated to move a hydraulic turning motor constituting a turning mechanism 430 of the work machine 40. The manipulation lever of the boom manipulation device (boom lever) is manipulated to move a boom cylinder 442 of the work machine 40. The manipulation lever of the arm manipulation device (arm lever) is manipulated to move an arm cylinder 444 of the work machine 40. The manipulation lever of the bucket manipulation device (bucket lever) is manipulated to move a bucket cylinder 446 of the work machine 40.

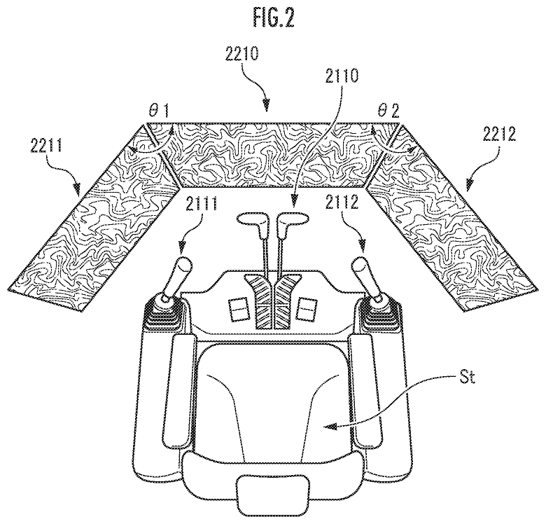

For example, as illustrated in FIG. 2, each of the manipulation levers constituting the remote manipulation mechanism 211 is arranged around a seat St on which an operator sits. The seat St has a form of a high-back chair with armrests; however, the seat St may be a seat portion having an optional form on which the operator can sit, such as a form of a low-back chair without a headrest and a form of a chair without a backrest.

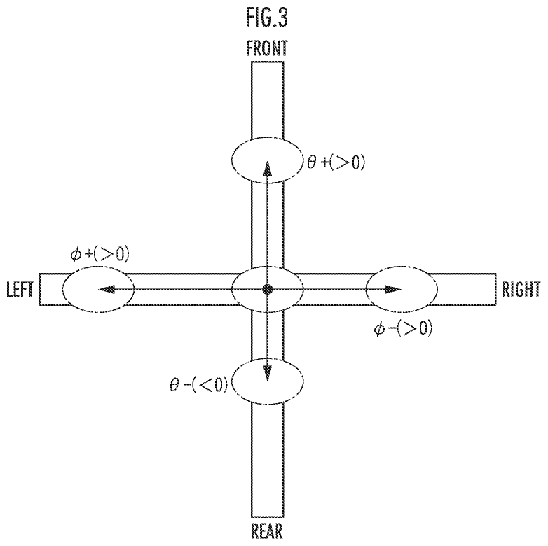

As illustrated in FIG. 3, manipulation levers 2111 and 2112 are cross manipulation levers, and are each configured to be displaceable or tiltable in a forward manipulation direction and a rearward manipulation direction (upward direction and downward direction in drawing), which are opposite to each other, and in a leftward manipulation direction and a rightward manipulation direction (leftward direction and rightward direction in drawing) that are perpendicular to the forward manipulation direction and the rearward manipulation direction and are opposite to each other. A manipulation amount of each of the manipulation levers 2111 and 2112 is represented or defined by a tilting angle in the forward manipulation direction θ=θ₊(>0), a tilting angle in the rearward manipulation direction θ=θ₋(<0), a tilting angle in the leftward manipulation direction φ =φ₊(>0), and a tilting angle in the rightward manipulation direction φ=φ₋(<0).

Each of the manipulation levers 2111 and 2112 maybe formed from an omnidirectional manipulation lever tilted to diagonally forward right, diagonally forward left, diagonally rearward right, and diagonally rearward left directions, in addition to the front-rear direction and the right-left direction. For example, in a case where each of the manipulation levers 2111 and 2112 is tilted diagonally forward right (simultaneously manipulated in forward manipulation direction and rightward manipulation direction), a manipulation amount of each of the manipulation levers 2111 and 2112 is defined by the tilting angle in the forward manipulation direction θ=θ₊ and the tilting angle in the rightward manipulation direction φ=φ. In a case where each of the manipulation levers 2111 and 2112 is tilted diagonally forward left (simultaneously manipulated in forward manipulation direction and leftward manipulation direction), the manipulation amount of each of the manipulation levers 2111 and 2112 is defined by the tilting angle in the forward manipulation direction θ=θ₊ and the tilting angle in the leftward manipulation direction φ=φ₊. In a case where each of the manipulation levers 2111 and 2112 is tilted diagonally rearward right (simultaneously manipulated in rearward manipulation direction and rightward manipulation direction), the manipulation amount of each of the manipulation levers 2111 and 2112 is defined by the tilting angle in the rearward manipulation direction θ=θ₋ and the tilting angle in the rightward manipulation direction φ=φ₋. In a case where each of the manipulation levers 2111 and 2112 is tilted diagonally rearward left (simultaneously manipulated in rearward manipulation direction and leftward manipulation direction), the manipulation amount of each of the manipulation levers 2111 and 2112 is defused by the tilting angle in the rearward manipulation direction θ=θ₋ and the tilting angle in the leftward manipulation direction φ=φ₊.

Paired right and left traveling levers 2110 corresponding to right and left crawlers are laterally arranged side by side in front of the seat St. One manipulation lever may also serve as a plurality of manipulation levers. For example, the left manipulation lever 2111 provided in front of a left frame of the seat St illustrated in FIG. 2 may function as the aim lever in a case of being manipulated in a front-rear direction and may function as the turning lever in a case of being manipulated in a right-left direction. Likewise, the right manipulation lever 2112 provided in front of a right frame of the seat St illustrated in FIG. 2 may function as the boom lever in a case of being manipulated in the front-rear direction and may function as the bucket lever in a case of being manipulated in the right-left direction. A lever pattern may be optionally changed by a manipulation instruction from the operator.

The operating manner detection sensor 212 includes, for example, a contact or non-contact angular sensor. The operating manner detection sensor 212 is configured to output a signal corresponding to any of the forward manipulation direction and the rearward manipulation direction (paired manipulation directions opposite to each other) and the leftward manipulation direction and the rightward manipulation direction (paired manipulation directions opposite to each other) as the manipulation direction or the tilting direction of each of the left manipulation lever 2111 and the right manipulation lever 2112, and a signal corresponding to a size or an absolute value of the tilting angle as the manipulation amount of each of the left manipulation lever 2111 and the right manipulation lever 2112. The output signals are input to the remote control device 200, and are stored and held in the storage device of the remote control device 200.

In a case where a slide switch slidable forward, rearward, rightward, and leftward constitutes the remote manipulation mechanism 211 in place of or in addition to each of the manipulation levers 2111 and 2112, a slide direction and a slide amount (displacement amount) of the switch may be recognized as an operating manner of the remote manipulation mechanism 211. The tilting angles of the paired right and left traveling levers 2110, or turning angles or displacement amounts of members coupled thereto may be detected as manipulation amounts.

The actuators 214 each include, for example, an electric motor. The paired actuators 214 are coupled to the left manipulation lever 2111 and the right manipulation lever 2112 through different power transmission mechanisms. Each of the actuators 214 is configured to cause manipulation reaction forces corresponding to the manipulation amounts to act on the left manipulation lever 2111 and the right manipulation lever 2112 in directions opposite to the manipulation directions. The operation of the actuators 214 is controlled by the remote control device 200.

For example, as illustrated in FIG. 2, the remote image output device 221 includes a center remote image output device 2210, a left remote image output device 2211, and a right remote image output device 2212 each having a substantially rectangular screen and respectively arranged in front of, in left oblique front of, and in right oblique front of the seat St. Shapes and sizes of the screens (image display regions) of the center remote image output device 2210, the left remote image output device 2211, and the right remote image output device 2212 may be the same as or different from one another.

As illustrated in FIG. 2, a right edge of the left remote image output device 2211 is adjacent to a left edge of the center remote image output device 2210 such that the screen of the center remote image output device 2210 and the screen of the left remote image output device 2211 form an inclination angle θ₁ (for example, 120°≤θ₁≤150°). As illustrated in FIG. 2, a left edge of the right remote image output device 2212 is adjacent to a right edge of the center remote image output device 2210 such that the screen of the center remote image output device 2210 and the screen of the right remote image output device 2212 foam an inclination angle θ₂ (for example, 120°<θ₂<150°). The inclination angles θ₁ and θ₂ may be equal to or different from each other.

The screen of each of the center remote image output device 2210, the left remote image output device 2211, and the right remote image output device 2212 may be parallel to a vertical direction, or may be inclined to the vertical direction. At least one of the center remote image output device 2210, the left remote image output device 2211, and the right remote image output device 2212 may include a plurality of divided image output devices. For example, the center remote image output device 2210 may include paired image output devices vertically adjacent to each other and each including a substantially rectangular screen.

### (Configuration of Work Machine)

The work machine 40 comprises an actual machine control device 400, an actual machine input interface 41, an actual machine output interface 42, and a work mechanism 440. The actual machine control device 400 includes a calculation processing device (single core processor, multicore processor, or processor core constituting one of single core processor and multicore processor), reads necessary data and software from a storage device such as a memory, and performs calculation processing on the data based on the software.

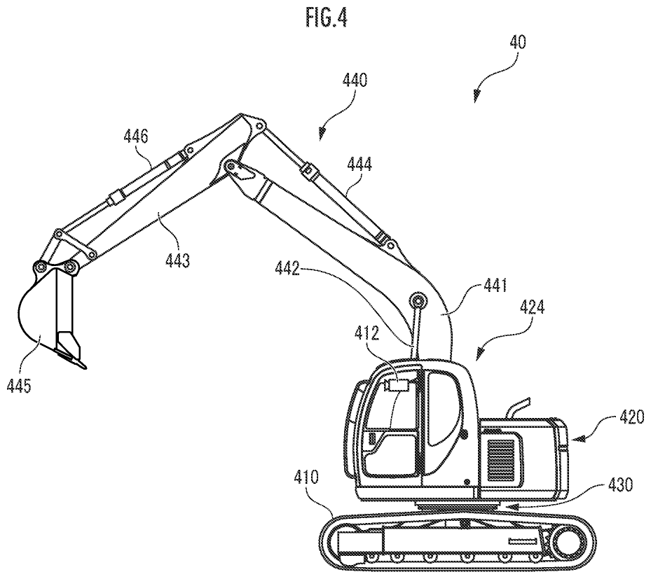

The work machine 40 is, for example, a crawler shovel (construction machine) of hydraulic type, electric type, or hybrid driven type including hydraulic type and electric type in combination. As illustrated in FIG. 4, the work machine 40 comprises the crawler lower travelling body 410, and an upper turning body 420 turnably mounted on the lower travelling body 410 through a turning mechanism 430. A cab 424 (operation room) is provided on a front left part of the upper turning body 420. The work mechanism 440 is provided on a front center part of the upper turning body 420.

The actual machine input interface 41 comprises an actual machine manipulation mechanism 411, an actual machine imaging device 412, and an actual machine state sensor group 414. The actual machine manipulation mechanism 411 comprises a plurality of manipulation levers arranged in a manner similar to the remote manipulation mechanism 211, around a seat disposed inside the cab 424. A driving mechanism or a robot that receives signals corresponding to operating manners of the remote manipulation levers and moves the actual machine manipulation levers based on the received signals is provided in the cab 424. The actual machine imaging device 412 is installed, for example, inside the cab 424, and images an environment including at least a part of the work mechanism 440 through a front window and paired right and left side windows. A part or all of the front window (or window frame) and the side windows may be omitted. The actual machine state sensor group 414 comprises angular sensors measuring a rotating angle (derrick angle) of a boom 441 relative to the upper turning body 420, a rotating angle of an arm 443 relative to the boom 441, and a rotating angle of a bucket 445 relative to the aim 443, a turning angle sensor measuring a turning angle of the upper turning body 420 relative to the lower travelling body 410, an external force sensor measuring external force acting on the bucket 445, a triaxial acceleration sensor measuring triaxial acceleration acting on the upper turning body 420, and the like.

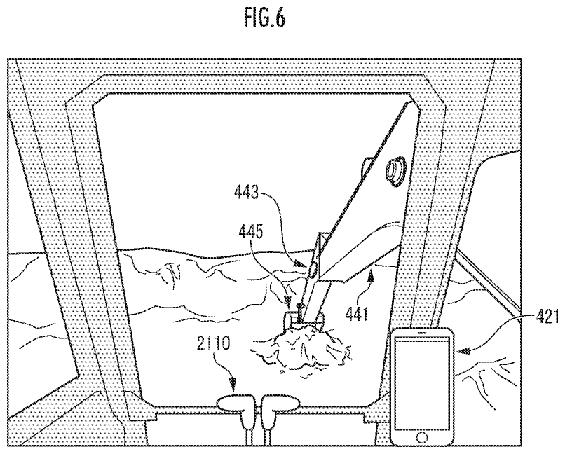

The actual machine output interface 42 comprises an actual machine image output device 421 and an actual machine wireless communication device 422. The actual machine image output device 421 is disposed, for example, at a position near the front window inside the cab 424 (see FIG. 6). The actual machine image output device 421 may be omitted.

The work mechanism 440 comprises the boom 441 mounted on the upper turning body 420 so as to derrick, the arm 443 rotatably coupled to a front end of the boom 441, and the bucket 445 rotatably coupled to a front end of the arm 443. The boom cylinder 442, the arm cylinder 444, and the bucket cylinder 446 each including an expandable hydraulic cylinder are mounted on the work mechanism 440. As a work portion, an attachment such as a nibbler, a cutter, and a magnet may be used besides the bucket 445.

The boom cylinder 442 is interposed between the boom 441 and the upper turning body 420 so as to expand/contract by receiving supply of hydraulic oil to rotate the boom 441 in a derricking direction. The arm cylinder 444 is interposed between the arm 443 and the boom 441 so as to expand/contract by receiving supply of hydraulic oil to rotate the aim 443 around a horizontal axis relative to the boom 441. The bucket cylinder 446 is interposed between the bucket 445 and the arm 443 so as to expand/contract by receiving supply of hydraulic oil to rotate the bucket 445 around a horizontal axis relative to the arm 443.

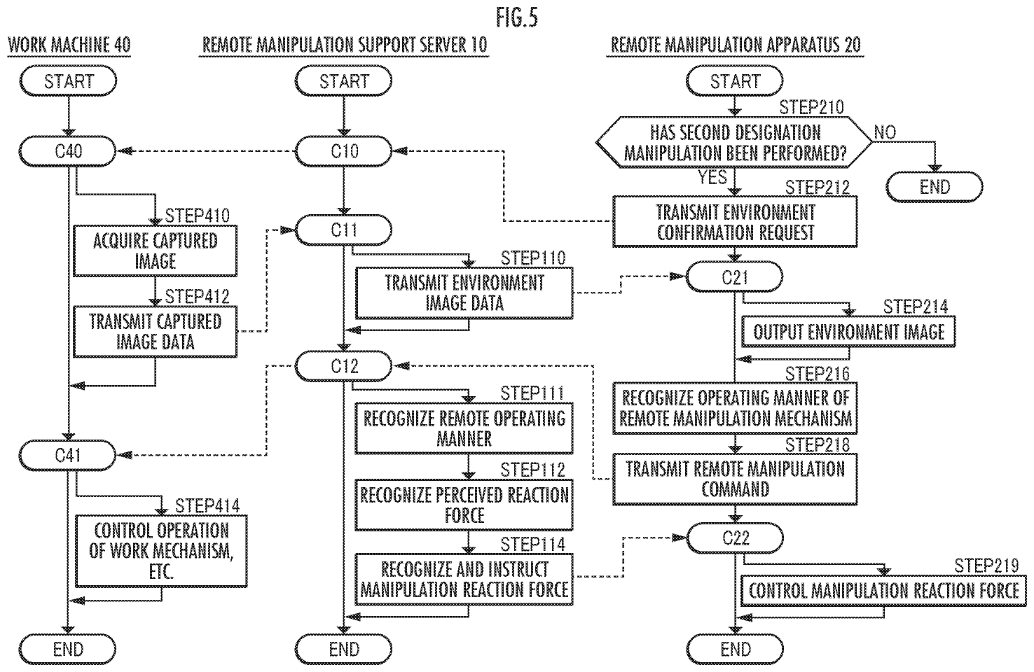

Functions of a remote manipulation support system including the remote manipulation support server 10, the remote manipulation apparatus 20, and the work machine 40 configured as described above are described with reference to a flowchart illustrated in FIG. 5. The functions include functions of the system for controlling manipulation reaction force 110 as the embodiment of the present invention. In the flowchart, a block “C●” is used to simplify description, means transmission and/or reception of data, and means a conditional branch in which processing in a branch direction is performed on condition of transmission and/or reception of the data.

The remote manipulation apparatus 20 determines whether designation manipulation has been performed by the operator through the remote input interface 210 (FIG. 5/STEP210). The “designation manipulation” is manipulation such as tapping on the remote input interface 210 for designating the work machine 40 to be remotely operated by the operator. In a case where a determination result is negative (FIG. 5/STEP210, NO), the series of processing ends. In contrast, in a case where the determination result is positive (FIG. 5/STEP210, YES), an environment confirmation request is transmitted to the remote manipulation support server 10 through the remote wireless communication device 224 (FIG. 5/STEP212).

In a case where the remote manipulation support server 10 receives the environment confirmation request, the first support processing element 121 transmits the environment confirmation request to the corresponding work machine 40 (FIG. 5/C 10).

In a case where the work machine 40 receives the environment confirmation request through the actual machine wireless communication device 422 (FIG. 5/C40), the actual machine control device 400 acquires a captured image through the actual machine imaging device 412 (FIG. 5/STEP410). The actual machine control device 400 transmits captured image data indicating the captured image to the remote manipulation support server 10 through the actual machine wireless communication device 422 (FIG. 5/STEP412).

In a case where the first support processing element 121 of the remote manipulation support server 10 receives the captured image data (FIG. 5/C 11), the second support processing element 122 transmits environment image data corresponding to the captured image to the remote manipulation apparatus 20 (FIG. 5/STEP 110). The environment image data includes, in addition to the captured image data itself, image data indicating a simulated environment image generated based on the captured image.

In a case where the remote manipulation apparatus 20 receives the environment image data through the remote wireless communication device 224 (FIG. 5/C21), the remote control device 200 outputs the environment image corresponding to the environment image data to the remote image output device 221 (FIG. 5/STEP214).

As a result, for example, as illustrated in FIG. 6, the environment image including the boom 441, the aim 443, and the bucket 445 that are parts of the work mechanism 440 is output to the remote image output device 221.

In the remote manipulation apparatus 20, the remote control device 200 recognizes the operating manner of the remote manipulation mechanism 211 (FIG. 5/STEP216), and transmits a remote manipulation command corresponding to the operating manner to the remote manipulation support server 10 through the remote wireless communication device 224 (FIG. 5/STEP218).

In a case where the second support processing element 122 of the remote manipulation support server 10 receives the remote manipulation command, the fast support processing element 121 transmits the remote manipulation command to the work machine 40 (FIG. 5/C 12).

In a case where the actual machine control device 400 of the work machine 40 receives the manipulation command through the actual machine wireless communication device 422 (FIG. 5/C41), operation of the work mechanism 440 and the like is controlled (FIG. 5/STEP414). For example, a work in which the bucket 445 scoops soil in front of the work machine 40, and the soil is dropped from the bucket 445 after the upper turning body 420 is turned is performed.

In a case where the second support processing element 122 of the remote manipulation support server 10 receives the remote manipulation command (FIG. 5/C 12), the operating manner recognition element 111 of the system for controlling manipulation reaction force 110 recognizes (estimates) each of the manipulation directions of the left manipulation lever 2111 and the right manipulation lever 2112 constituting the remote manipulation mechanism 211, as the operating manners of the remote manipulation mechanism 211 reflected on the remote manipulation command (FIG. 5/STEP111).

For example, the tilting angle θ of each of the manipulation levers 2111 and 2112 at a neutral position (or rotating angle or displacement amount of member coupled to each of manipulation levers 2111 and 2112) is defined as “zero”, the tilting angle θ in a case where each of the manipulation levers 2111 and 2112 is tilted forward is defined as positive (0<θ), and the tilting angle θ in a case where each of the manipulation levers 2111 and 2112 is tilted rearward is defined as negative (θ<0). The tilting angle φ of each of the manipulation levers 2111 and 2112 at the neutral position (or rotating angle or displacement amount of member coupled to each of manipulation levers 2111 and 2112) is defined as “zero”, the tilting angle φ in a case where each of the manipulation levers 2111 and 2112 is tilted leftward is defined as positive (0<φ), and the tilting angle φ in a case where each of the manipulation levers 2111 and 2112 is tilted rightward is defined as negative (φ<0).

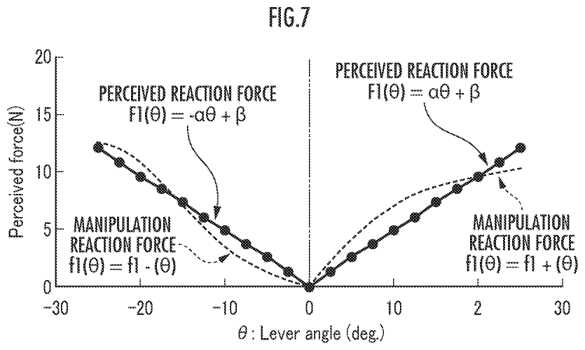

Thereafter, based on the operating manner of the remote manipulation mechanism 211 recognized by the operating manner recognition element 111, the perceived reaction force recognition element 112 recognizes perceived reaction force that is reaction force perceived by the operator (FIG. 5/STEP112). For example, as illustrated by a solid line in FIG. 7, a first perceived reaction force F₁ is recognized based on a first perceived reaction force characteristic curve F₁(θ) using, as a main variable, the tilting angle θ in the frontward/rearward manipulation direction of each of the manipulation levers 2111 and 2112. In FIG. 7, the first perceived reaction force characteristic curve F₁(θ) is defined as a linear function having symmetry in positive and negative definition ranges, represented by F₁(θ)=−αθ+β(θ<0(0<α, 0≤β)), F₁(θ)=αθ+β(0<θ).

The first perceived reaction force characteristic curve F₁(θ) corresponding to the manipulation amount θ of each of the manipulation levers 2111 and 2112 in the forward manipulation direction and the rearward manipulation direction and a second perceived reaction force curve F₂(φ) corresponding to the manipulation amount φ of each of the manipulation levers 2111 and 2112 in the leftward manipulation direction and the rightward manipulation direction may be functions common in at least a part of the definition ranges.

The first perceived reaction force characteristic curve F₁(θ) in the forward/rearward manipulation direction (first perceived reaction force F₁ in forward/rearward manipulation direction as well) may be defined so as to have symmetry in the whole of the negative definition range [−Θ, 0] and the positive definition range [0, Θ] (for example, Θ is about +25 degrees) as illustrated in FIG. 7, or may be defined so as to have symmetry in partial ranges [−θ₂, −θ₁] and [θ₁, θ₂] (for example, θ₁ is about +5 degrees, and θ₂ is about +20 degrees). The first perceived reaction force characteristic curve F₁(θ) maybe defined by, in addition to a linear function, an exponential function, a logarithmic function, an n-order function (2≤n), or a combination thereof within at least ranges having symmetry in the positive and negative definition ranges. The first perceived reaction force characteristic curve F₁(θ) (dependent variable) is defined such that the value is continuously increased as an absolute value of the manipulation amount θ (main variable) in the forward/rearward manipulation direction is increased, but may be defined such that the value is locally reduced while the value shows a tendency to be increased in a process in which the absolute value of the manipulation amount θ (main variable) is increased.

The second perceived reaction force characteristic curve F₂(φ) in the rightward/leftward manipulation direction (second perceived reaction force F₂ in rightward/leftward manipulation direction as well) may be defined so as to have symmetry in the whole of the negative definition range [−Φ, 0] and the positive definition range [0, Φ] (for example, Φ is about +25 degrees), or may be defined so as to have symmetry in partial ranges [−φ₂, −φ₁] and [φ₁, φ₂] (for example, φ₁ is about +10 degrees, and φ₂ is about +25 degrees) (see FIG. 7). The second perceived reaction force characteristic curve F₂(φ) may be defined by, in addition to a linear function, an exponential function, a logarithmic function, an n-order function (2≤n), or a combination thereof within at least ranges having symmetry in the positive and negative definition ranges. The second perceived reaction force characteristic curve F₂(φ) (dependent variable) is defined such that the value is continuously increased as an absolute value |φ| of the manipulation amount φ (main variable) in the rightward/leftward manipulation direction is increased, but may be defined such that the value is locally reduced while the value shows a tendency to be increased in a process in which the absolute value |φ| of the manipulation amount φ (main variable) is increased.

Further, based on the first perceived reaction force F₁(θ) and/or the second perceived reaction force F₂(φ) recognized by the perceived reaction force recognition element 112, each of a first manipulation reaction force f₁(θ) and/or a second manipulation reaction force f₂(φ) or a control command signal representing the first manipulation reaction force f₁(θ) and/or the second manipulation reaction force f₂(φ) is recognized by the manipulation reaction force recognition element 114, and is transmitted to the remote manipulation apparatus 20 (FIG. 5/STEP114). For example, as illustrated by a dashed line in FIG. 7, the first manipulation reaction force f₁ is recognized based on a first manipulation reaction force characteristic curve f₁(θ) using, as a main variable, the tilting θ in the forward/rearward manipulation direction of each of the manipulation levers 2111 and 2112.

The first manipulation reaction force characteristic curve f₁(θ) corresponding to the manipulation amount θ of each of the manipulation levers 2111 and 2112 in the forward manipulation direction and the rearward manipulation direction and the second manipulation reaction force curve f₂(φ) corresponding to the manipulation amount (of each of the manipulation levers 2111 and 2112 in the leftward manipulation direction and the rightward manipulation direction may be functions common in at least a part of the definition ranges.

As illustrated in FIG. 7, the first manipulation reaction force characteristic curve f₁(θ) is defined as a function asymmetrical in the positive and negative definition ranges, represented by f₁(θ)=f₁−(θ) (θ<0), f₁+(θ)(0<θ). The first manipulation reaction force characteristic curve f₁(θ) and the first perceived reaction force characteristic curve F₁(θ) have fixed correlation. The correlation is defined, for example, based on a relational expression (01).

$${f}_{1} ( θ ) = {ε}_{1} {log F}_{1} ( θ ) + {δ}_{1} . \qquad ( 01 )$$

Alternatively, the correlation may be defined based on a relational expression (11) using a coefficient c₁(θ) that depends on the manipulation amount θ in the forward/rearward manipulation direction.

$${f}_{1} ( θ ) = {c}_{1} ( θ ) \cdot {F}_{1} ( θ ) . \qquad ( 11 )$$

The first manipulation reaction force characteristic curve f₁(θ) in the forward/rearward manipulation direction (first manipulation reaction force f₁ as well) may be defined so as to have symmetry in at least partial ranges [−θ₂, −θ₁] and [θ₁, θ₂] (for example, 01 is about +5 degrees, and θ₂ is about +20 degrees) of the negative definition range [−Θ, 0] and the positive definition range [0, Θ] (for example, Θ is about +25 degrees). The fast manipulation reaction force characteristic curve f₁(θ) may be defined by, in addition to a linear function, an exponential function, a logarithmic function, an n-order function (2≤n), or a combination thereof. The first manipulation reaction force characteristic curve f₁(θ) (dependent variable) is defined such that the value is continuously increased as an absolute value |θ| of the manipulation amount θ (main variable) in the forward/rearward manipulation direction is increased, but may be defined such that the value is locally reduced while the value shows a tendency to be increased in a process in which the absolute value |θ| of the manipulation amount θ (main variable) is increased.

The second manipulation reaction force characteristic curve f₂(φ) is defined as a function asymmetrical in the positive and negative definition ranges, represented by f₂(φ) =f₂ (φ) (φ<0), f₂+(φ) (0<φ). The second manipulation reaction force characteristic curve f₂(φ) and the second perceived reaction force characteristic curve F₂(φ) have fixed correlation. The correlation is defined, for example, based on a relational expression (02).

$${f}_{2} ( φ ) = {ε}_{2} {log F}_{2} ( φ ) + {δ}_{2} . \qquad ( 02 )$$

Alternatively, the correlation may be defined based on a relational expression (12) using a coefficient c₂(φ) that depends on the manipulation amount (p in the rightward/leftward manipulation direction.

$${f}_{2} ( φ ) = {c}_{2} ( φ ) \cdot {F}_{2} ( φ ) . \qquad ( 12 )$$

The second manipulation reaction force characteristic curve f₂(φ) in the rightward/leftward manipulation direction (second manipulation reaction force f₂ as well) may be defined so as to have symmetry in at least partial ranges [−φ₂, −φ₁] and [φ₁, φ₂] (for example, φ₁ is about +10 degrees, and φ₂ is about +25 degrees) of the negative definition range [−Φ, 0] and the positive definition range [0, Φ] (for example, Φ is about +25 degrees). The second manipulation reaction force characteristic curve f₂(φ) may be defined by, in addition to a linear function, an exponential function, a logarithmic function, an n-order function (2≤n), or a combination thereof. The second manipulation reaction force characteristic curve f₂(φ) (dependent variable) is defined such that the value is continuously increased as an absolute value |φ| of the manipulation amount φ (main variable) in the rightward/leftward manipulation direction is increased, but may be defined such that the value is locally reduced while the value shows a tendency to be increased in a process in which the absolute value |φ| of the manipulation amount φ (main variable) is increased.

In a case where the remote manipulation apparatus 20 receives the first manipulation reaction force f₁(θ) and/or the second manipulation reaction force f₂(φ) or the control command signal representing the first manipulation reaction force f₁(θ) and/or the second manipulation reaction force f₂(φ) through the remote wireless communication device 224 (FIG. 5/C22), the operation of the actuator 214 is controlled by the remote control device 200 such that the first manipulation reaction force f₁(θ) and/or the second manipulation reaction force f₂(φ) (force pushing back tilted manipulation lever 2111 or 2112 in opposite direction) acts on the corresponding manipulation lever 2111 or 2112 in the direction opposite to the manipulation direction (FIG. 5/STEP219). This enables the operator holding grips or holding portions of the manipulation levers 2111 and 2112 to perceive the first perceived reaction force F₁(θ) and/or the second perceived reaction force F₂(φ) corresponding to the first manipulation reaction force f₁(θ) and/or the second manipulation reaction force f₂(φ) through the manipulation levers 2111 and 2112.

### (Effects)

According to the system for controlling manipulation reaction force 110 constituting the remote manipulation support system configured as described above, the operation of the actuator 214 is controlled based on the manipulation amount θ of each of the left manipulation lever 2111 and/or the right manipulation lever 2112 constituting the remote manipulation mechanism 211 in each of the forward manipulation direction (positive manipulation direction) and the rearward manipulation direction (negative manipulation direction), which are opposite to each other. As a result, the first manipulation reaction force f₁(θ) acts on the left manipulation lever 2111 and/or the right manipulation lever 2112 in the direction opposite to the manipulation direction (see FIG. 7/dashed line). Likewise, the operation of the actuator 214 is controlled based on the manipulation amount (p of each of the left manipulation lever 2111 and/or the right manipulation lever 2112 constituting the remote manipulation mechanism 211 in each of the leftward manipulation direction (positive manipulation direction) and the rightward manipulation direction (negative manipulation direction), which are opposite to each other. As a result, the second manipulation reaction force f₂(φ) acts on the left manipulation lever 2111 and/or the right manipulation lever 2112 in the direction opposite to the manipulation direction.

At this time, the operation of the actuator 214, and furthermore, the first manipulation reaction force F₁(θ) acting on the left manipulation lever 2111 and/or the right manipulation lever 2112 is controlled such that the reaction force (first perceived reaction force F₁(θ)) in the rearward manipulation direction and the forward manipulation direction perceived by the operator through the left manipulation lever 2111 and/or the right manipulation lever 2112 (manipulation mechanism) realizes symmetry about the manipulation amount of zero within the manipulation amount range in the forward manipulation direction (positive manipulation direction) (positive definition range [0, Θ]) and the manipulation amount range in the negative manipulation direction (negative definition range [−Θ, 0]) (see FIG. 7/solid line). Likewise, the operation of the actuator 214, and furthermore, the second manipulation reaction force F₂(φ) acting on the left manipulation lever 2111 and/or the right manipulation lever 2112 is controlled such that the reaction force (second perceived reaction force F₂(φ)) in the rightward manipulation direction and the leftward manipulation direction perceived by the operator through the left manipulation lever 2111 and/or the right manipulation lever 2112 (manipulation mechanism) realizes symmetry about the manipulation amount of zero within the manipulation amount range in the leftward manipulation direction (positive manipulation direction) (positive definition range [0, Φ]) and the manipulation amount range in the negative manipulation direction (negative definition range [−Φ, 0]) (see FIG. 7/solid line).

As a result, in each of the positive manipulation direction and the negative manipulation direction, which are opposite to each other, the manipulation amounts θ and (p of the left manipulation lever 2111 and/or the right manipulation lever 2112 and the perceived reaction forces F₁(θ) and F₂(φ) by the operator are made equal to or matched with each other, which makes it possible to improve operability of the left manipulation lever 2111 and/or the right manipulation lever 2112 for the operator.

Further, the first manipulation reaction force f₁(θ) is controlled such that the fast perceived reaction forces F₁(+θ) and F₁(−θ) respectively corresponding to the manipulation amount +θ in the forward manipulation direction (positive manipulation direction) and the manipulation amount −θ in the rearward manipulation direction (negative manipulation direction) equal in absolute value to the manipulation amount +θ are equal to each other and linearly varied (see FIG. 7/solid line and dashed line). Likewise, the second manipulation reaction force f₂(θ) is controlled such that the second perceived reaction forces F₂(+φ) and F₂(−φ) respectively corresponding to the manipulation amount +φ in the leftward manipulation direction (positive manipulation direction) and the manipulation amount −φ in the rightward manipulation direction (negative manipulation direction) equal in absolute value to the manipulation amount +φ are equal to each other and linearly varied. This enables the operator to easily grasp the relationship between the manipulation amounts θ and φ of the manipulation levers 2111 and 2112 and the perceived reaction forces F₁ and F₂ through the manipulation levers 2111 and 2112, in each of the positive manipulation direction and the negative manipulation direction, which are opposite to each other. This further improves operability of the manipulation levers 2111 and 2112 for the operator.

### (Other Embodiments of Present Invention)

In the above-described embodiment, the system for controlling manipulation reaction force 110 is fanned from the remote manipulation support server 10; however, the system for controlling manipulation reaction force 110 may be formed from the remote manipulation apparatus 20 and/or the work machine 40 as another embodiment. In other words, the remote manipulation apparatus 20 and/or the work machine 40 may include functions as the operating manner recognition element 111, the perceived reaction force recognition element 112, and the manipulation reaction force recognition element 114.

The work machine 40 may not be remotely manipulated by the operator through the remote manipulation mechanism 211 constituting the remote manipulation apparatus 20, but the work machine 40 may be actually manipulated by the operator getting on the work machine 40 through the actual machine manipulation mechanism 411. In this case, the remote manipulation support server 10 and the remote manipulation apparatus 20 may be omitted. The system for controlling manipulation reaction force 110 may be mounted on the work machine 40 together with the operating manner detection sensor 212 for detecting the operating manner (manipulation direction and manipulation amount) by the operator, of the actual machine manipulation levers constituting the actual machine manipulation mechanism 411. The system for controlling manipulation reaction force 110 may comprise the actual machine manipulation mechanism 411 (or actual machine manipulation levers constituting actual machine manipulation mechanism 411), and the operating manner detection sensor 212.

The system for controlling manipulation reaction force 110 may be configured to control the operation of the actuators 214 based on the perceived reaction force estimated from an attribute factor that indicates an attribute of the operator input through the remote input interface 210 (for example, touch panel device). The “attribute factor” may include a factor or a parameter indicating, for example, a physical attribute such as a body height, lengths of extremities, grip strength, arm strength, leg strength, visual acuity, hearing acuity, a body-fat percentage, and/or a weight of the operator, and a social attribute such as residence, years of operator experience (work experience), and exercise history. Based on the attribute factor (γ₁, γ₂, . . . , γₙ), the above-described first perceived reaction force characteristic curve F₁(θ) is estimated from a multivariable function F₁(θ, γ₁, γ₂, . . . , γₙ), and/or the second perceived reaction force characteristic curve F₂(φ) is estimated from a multivariable function F₂(φ, γ₁, γ₂, . . . , γₙ).

For example, based on one attribute factor γₚ (for example, muscle activity), the manipulation amounts θ of the manipulation levers 2111 and 2112 in the forward/rearward manipulation direction, and the fast manipulation reaction force f₁(θ), a θ dependence of each of coefficients ξ₁(θ), and η₁(θ) is determined from a relational expression (21). Likewise, based on one attribute factor γₚ, the manipulation amounts θ of the manipulation levers 2111 and 2112 in the rightward/leftward manipulation direction, and the second manipulation reaction force f₂(φ), a φ dependence of each of coefficients ξ₂(φ) and η₂(φ) is determined from a relational expression (22).

$${γ}_{p} = {ξ}_{1} ( θ ) {f}_{1} ( θ ) + {η}_{1} ( θ ) . \qquad ( 21 )$$

$${γ}_{p} = {ξ}_{2} ( φ ) {f}_{2} ( φ ) + {η}_{2} ( φ ) . \qquad ( 22 )$$

Further, based on the coefficients ξ₁(θ) and η₁(θ), the θ dependence of at least one of the coefficients ξ₁, η₁, a₁, and b₁ is determined from a relational expression (31). Likewise, based on the coefficients ξ₂(φ) and η₂(φ), the (dependence of at least one of the coefficients ξ₂, η₂, a₂, and b₂ is determined from a relational expression (32).

$${c}_{1} ( θ ) = {ξ}_{1} ( {a}_{1} log \{ ( {ξ}_{1} ( θ ) {f}_{1} ( θ ) + {η}_{1} ( θ ) - {η}_{1} ) / {ξ}_{1} \} + {b}_{1} ) \div ( {ξ}_{1} ( θ ) {f}_{1} ( θ ) + {η}_{1} ( θ ) - {η}_{1} ) . \qquad ( 31 )$$

$${c}_{2} ( φ ) = {ξ}_{2} ( {a}_{2} log \{ ( {ξ}_{2} ( φ ) {f}_{2} ( φ ) + {η}_{2} ( φ ) - {η}_{2} ) / {ξ}_{2} \} + {b}_{2} ) \div ( {ξ}_{2} ( φ ) {f}_{2} ( φ ) + {η}_{2} ( φ ) - {η}_{2} ) . \qquad ( 32 )$$

Based on the manipulation amounts θ of the manipulation levers 2111 and 2112 in the forward/rearward manipulation direction and the 0 dependence of the coefficients, the coefficient c₁(θ), and furthermore, the first manipulation reaction force f₁(θ) is recognized and controlled (see relational expression (11)). Based on the manipulation amounts (p of the manipulation levers 2111 and 2112 in the rightward/leftward manipulation direction and the (p dependence of the coefficients, the coefficient c₂(φ), and furthermore, the first manipulation reaction force f₂(φ) is recognized and controlled (see relational expression (12)).

According to the system for controlling manipulation reaction force 110 configured as described above, in each of the positive manipulation direction and the negative manipulation direction, which are opposite to each other, the manipulation amounts of the manipulation levers 2111 and 2112 and the perceived reaction forces estimated from the attribute of the operator are made equal to or matched with each other while individual difference of the perceived reaction force among operators is reflected, which makes it possible to improve operability of the manipulation levers 2111 and 2112 for the operator.

The system for controlling manipulation reaction force 110 may be configured to control the operation of the actuator 214 based on the perceived reaction force perceived by the operator through the left manipulation lever 2111 and/or the right manipulation lever 2112 on which the manipulation reaction force acts, input through the remote input interface 210 (for example, touch panel device).

For example, the actuator 214 causes the operator to recognize the perceived reaction force F of “100” through the remote image output device 221 in a state where reference manipulation reaction force f=f₀(≠0) acts on the manipulation levers 2111 and 2112. In a case where one or a plurality of test manipulation reaction forces f=κ₁f₀, κ₂f₀, . . . , κₘf₀(0<κ₁<κ₂< . . . <Kₘ) act on the manipulation levers 2111 and 2112, the reaction forces F=ξ₁, ξ₂, . . . , ξₘ perceived through the manipulation levers 2111 and 2112 are input to the remote input interface 210 by the operator. Based on one or a plurality of coefficient values (κ₁, κ₂, . . . , κₘ) defining strength of the test manipulation reaction forces and the coefficient values (ξ₁, ξ₂, . . . , ξₘ) defining strength of the perceived reaction forces F, the coefficients (ε₁, δ₁) in the relational expression (01) and/or the coefficients (ε₂, δ₂) in the relational expression (02), or the coefficient c₁(θ) in the relational expression (11) and/or the coefficient c₂(φ) in the relational expression (12) are determined.

As a result, based on the coefficients (ε₁, δ₁) or the coefficient c₁(θ) in addition to the fast perceived reaction force characteristic curve F₁(θ) (see FIG. 7/solid line) as a target or a reference, the fast manipulation reaction force characteristic curve f₁(θ) is estimated (see relational expressions (01) and (11), and FIG. 7/dashed line). Likewise, based on the coefficients (ε₂, δ₂) or the coefficient c₂(φ) in addition to the second perceived reaction force characteristic curve F₂(φ) (see FIG. 7/solid line) as a target or a reference, the second manipulation reaction force characteristic curve f₂(φ) is estimated (see relational expressions (02) and (12), and FIG. 7/dashed line). Further, the operation of the actuator 214 is controlled so as to realize the manipulation reaction force f₁(θ) and/or f₂(φ).

According to the system for controlling manipulation reaction force 110 configured as described above, individual difference of the perceived reaction forces among operators is reflected. On that basis, in each of the positive manipulation direction and the negative manipulation direction, which are opposite to each other, the manipulation amounts of the manipulation levers 2111 and 2111 and the perceived reaction forces as a result actually perceived by the operator are made equal to or matched with each other. This makes it possible to improve operability of the manipulation levers 2111 and 2112 for the operator.

The system for controlling manipulation reaction force 110 configured as described above is preferably configured to control operation of the actuator to linearly vary the perceived reaction forces based on the manipulation amount of the manipulation mechanism realizing the symmetry.

According to the system for controlling manipulation reaction force 110 configured as described above, the manipulation reaction force f(X) is controlled such that the perceived reaction forces F(+X) and F(−X) respectively corresponding to the manipulation amount +X in the positive manipulation direction and the manipulation amount −X in the negative manipulation direction equal in absolute value to the manipulation amount +X are equal to each other and linearly varied (F(X)=αX+β(X>0), =−αX+β(X<0)). This enables the operator to easily grasp the relationship between the manipulation amount of the manipulation mechanism and the perceived reaction force through the manipulation mechanism, in each of the positive manipulation direction and the negative manipulation direction, which are opposite to each other. This further improves operability for the operator.

The system for controlling manipulation reaction force according to the present invention is preferably configured to control the operation of the actuator based on the perceived reaction force estimated from the attribute factor indicating the attribute of the operator input through the input interface.

According to the system for controlling manipulation reaction force configured as described above, individual difference of the perceived reaction force among operators is reflected. On that basis, in each of the positive manipulation direction and the negative manipulation direction, which are opposite to each other, the manipulation amount of the manipulation mechanism and the perceived reaction force estimated from the attribute of the operator are made equal to or matched with each other. This makes it possible to improve operability of the manipulation mechanism for the operator.

The system for controlling manipulation reaction force according to the present invention is preferably configured to control the operation of the actuator based on the perceived reaction force as a manipulation reaction force perceived by the operator through the manipulation mechanism on which the manipulation reaction force acts, input through the input interface.

According to the system for controlling manipulation reaction force configured as described above, individual difference of the perceived reaction force among operators is reflected. On that basis, in each of the positive manipulation direction and the negative manipulation direction, which are opposite to each other, the manipulation amount of the manipulation mechanism and the perceived reaction force as a result actually perceived by the operator are made equal to or matched with each other. This makes it possible to improve operability of the manipulation mechanism for the operator.

The system for controlling manipulation reaction force according to the present invention preferably further comprises the actuator and the operating manner detection sensor.

The system for controlling manipulation reaction force configured as described above may be disposed in an operation manipulation environment of the operator, together with the actuator and the operating manner detection sensor.

### REFERENCE SIGNS LIST

10 Remote manipulation support server
20 Remote manipulation apparatus
40 Work machine
41 Actual machine input interface
42 Actual machine output interface
110 System for controlling manipulation reaction force
111 Operating manner recognition element
112 Perceived reaction force recognition element
114 Manipulation reaction force recognition element
200 Remote control device
210 Remote input interface
211 Remote manipulation mechanism
220 Remote output interface
221 Remote image output device (information output device)
224 Remote wireless communication device
412 Actual machine imaging device
414 Actual machine state sensor group
421 Actual machine image output device (information output device)
422 Actual machine wireless communication device
440 Work mechanism (work attachment)
445 Bucket (work portion)
2111 Left manipulation lever
2112 Right manipulation lever

1. A system for controlling manipulation reaction force configured to control operation of an actuator to cause a manipulation reaction force to act on a manipulation mechanism in a direction corresponding to a manipulation direction detected by an operating manner detection sensor, the manipulation reaction force being of strength corresponding to a manipulation amount detected by the operating manner detection sensor of the manipulation mechanism operated by an operator in a positive manipulation direction and a negative manipulation direction, which are opposite to each other, for a purpose of operating a work machine to be controlled or a component of the work machine in a positive operation direction and a negative operation direction, which are opposite to each other, wherein
the system for controlling manipulation reaction force is configured to control the operation of the actuator to cause a manipulation reaction force corresponding to the manipulation amount of the manipulation mechanism to act on the manipulation mechanism in the positive manipulation direction and the negative manipulation direction, such that a perceived reaction force is realized in at least partially a symmetrical manner about a manipulation amount of zero of the manipulation mechanism, the perceived reaction force being a manipulation reaction force perceived by the operator through the manipulation mechanism based on the manipulation amount of the manipulation mechanism in the positive manipulation direction and the negative manipulation direction.

2. The system for controlling manipulation reaction force according to claim 1, wherein the system for controlling manipulation reaction force is configured to control the operation of the actuator, to linearly vary the perceived reaction force based on the manipulation amount of the manipulation mechanism realizing the symmetry.

3. The system for controlling manipulation reaction force according to claim 1, wherein the system for controlling manipulation reaction force is configured to control the operation of the actuator based on the perceived reaction force estimated from an attribute factor indicating an attribute of the operator, input through an input interface.

4. The system for controlling manipulation reaction force according to claim 1, wherein the system for controlling manipulation reaction force is configured to control the operation of the actuator based on the perceived reaction force as a manipulation reaction force perceived by the operator through the manipulation mechanism on which the manipulation reaction force acts, input through an input interface.

5. The system for controlling manipulation reaction force according to claim 1, further comprising the actuator and the operating manner detection sensor.

6. A method for controlling manipulation reaction force, the method comprising:
an operating manner detection step of detecting a manipulation direction and a manipulation amount of a manipulation mechanism manipulated by an operator in a positive manipulation direction and a negative manipulation direction, which are opposite to each other, for a purpose of operating a work machine to be controlled or a component of the work machine in a positive operation direction and a negative operation direction, which are opposite to each other,; and
a reaction force control step of controlling operation of an actuator to cause a manipulation reaction force of strength corresponding to the manipulation amount detected in the operating manner detection step, to act on the manipulation mechanism in a direction corresponding to the manipulation direction detected in the operating manner detection step, wherein
the reaction force control step includes a step of controlling the operation of the actuator to cause a manipulation reaction force corresponding to the manipulation amount of the manipulation mechanism to act on the manipulation mechanism in the positive manipulation direction and the negative manipulation direction, such that a perceived reaction force is realized in at least partially a symmetrical manner about a manipulation amount of zero of the manipulation mechanism, the perceived reaction force being a manipulation reaction force perceived by the operator through the manipulation mechanism based on the manipulation amount of the manipulation mechanism in the positive manipulation direction and the negative manipulation direction.
